(19) United States
(12) Patent Application Publication
(10) Pub. No.: US 2005/0197932 A1
(43) Pub. Date: Sep. 8, 2005

(54) Method for displaying accumulated interest

(76) Inventor: George Gati, Middlesex (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/842,219

(22) Filed: May 10, 2004

(30) Foreign Application Priority Data
Mar. 3, 2004 (GB) 0404777.5

(51) Int. Cl. G06F 17/60

(52) U.S. Cl. 705/30

(57) ABSTRACT

A computer-implemented method for displaying the amount of interest that has accumulated on an account since a predetermined time in the past is provided. The method includes the steps of: selecting an account; calculating the amount of interest accumulated on said account since a predetermined time in the past; displaying said amount of interest. The method is preferably implemented in a computer program, and may be performed in conjunction with a web page on which the amount of interest is displayed. By implementing this method on their web pages, banks and other financial institutions can offer their customers a further service, which may thus afford a marketing advantage to the financial institution.

### BACKGROUND OF THE INVENTION

1. Field of the Invention

The present invention relates to a method for displaying accumulated interest, and more particularly to a method which be used with internet banking, for example by implementation in the web page of a financial institution.

2. Description of Related Art

With increasing use of and access to the World Wide Web (WWW or “the internet”), many companies are providing services to their customers through this medium, particularly in allowing customers to access information. This is particularly the case in the personal finance sector, where banks, building societies and other financial management companies are allowing customers to access their accounts via the internet. The web pages of such companies generally allow customers to view details of their account(s) such as the current balance, recent transactions etc., as well as perform standard tasks such as transferring money between different accounts, paying bills, requesting changes to overdraft and credit limits, etc.

The present invention allows a banking or other financial institution that either takes money on deposit or lends money out to offer an additional service to their customers.

An object of the present invention is to show on a continuously, or substantially continuously updated, dial or display, the interest that is being earned or that is accruing on money that is deposited, or alternatively the interest being charged on money borrowed.

Another object of the present invention is to provide a computer program which will allow customers to view at all times the state of their finances on deposited or borrowed money.

### BRIEF SUMMARY OF THE INVENTION

A first aspect of the present invention provides a computer-implemented method for displaying the amount of interest that has accumulated on an account since a predetermined time in the past, the method including the steps of: selecting an account; calculating the amount of interest accumulated on said account since a predetermined time in the past; and displaying said amount of interest.

Preferably the amount displayed is effectively constantly updated, and more preferably the amount displayed is updated at least once a second.

Preferably the amount displayed is displayed on a web page. The method of this aspect may further include the step of generating a web page on which the amount of interest is displayed. The web page may also include other details relating to the account, including one or more of the account balance (which may also be updated, or may be the account balance at the time the web page is generated); the applicable interest rate; any conditions applying to the account; or the time from which the amount of interest displayed has accumulated.

The web page may be specially adapted for display on communication devices other than standard computers, and in particular for display on portable devices such as personal organisers and mobile telephones.

The account may be an account where the customer is in credit (e.g. a savings account or a current account). In such a situation, a user can view the amount of interest which is accumulating on the account, and can watch that amount increase whilst he/she is watching. This feature will be of considerable interest to customers, and may provide a marketing advantage between banks or other financial institutions which otherwise offer substantially similar services.

Alternatively the account may be an account where the customer is in debit (e.g. a credit card account or a mortgage account). In such a situation a user can view the amount of interest that is accumulating on the account and will need to be repaid. This may help the user appreciate the impact of making further repayments to the account, or making further withdrawals as the rate at which the interest accumulates is either decreased or increased. Again, this feature will be of considerable interest to customers, and may thus provide a marketing advantage between banks or other financial institutions which otherwise offer substantially similar services.

The account may also be an account where the customer can be in both credit and debit, such as a current account with an overdraft facility. For such accounts a continued update of the interest displayed since a predetermined time in the past could cause the amount displayed to increase or decrease, according to changes in the balance of the account between credit and debit.

The present invention could also be applied to several accounts owned by a user, either combining the positive or negative accumulated interest from those accounts, or displaying both positive and negative accumulated interest from different accounts separately. For example, this may allow a user to observe profit accumulating from money that has been borrowed and re-lent at a higher rate, or alternatively the reduction in the amount of interest payable from an offset account (where all credit and debit balances from the different components of the account are set against each other).

The present invention is particularly suitable for use with accounts where the balance of the account changes fairly frequently, such as a current account, as a user will be able to observe the effects that the changes to the balance of the account have on the rate at which interest accumulates.

In a development of the present invention, the colour in which the interest is displayed may change depending on whether the interest is interest owing on an account that is in debit or interest accumulated on an account that is in credit.

In addition to accounts which handle cash deposits or debts, the present invention can also be applied to holdings of government bonds (gilts), corporate bonds and debentures, all of which are interest bearing. Such holdings may be with institutions which may not always be classified as financial institutions, such as stock brokers. For the purposes of the present invention the terms “financial institution” and “account” apply equally to such institutions and holdings.

The present invention is also applicable to accounts held with investment companies or other share trading institutions, particularly those that allow individuals to buy and sell shares electronically (e.g. over the internet). Customer accounts with such institutions generally include at least a portion which is held in cash, the amount of which may vary according to the purchases and/or sales made. The interest accumulating (or owing) on cash (or borrowings) in such an account may also be displayed in accordance with the present invention.

In a development of the present invention, the account may be a so called “phantom holding” or “shadow account”, i.e. an account which is fictitious. Many internet based organisations offer such trading schemes, particularly in relation to stocks and shares, in which a user can perform virtual trades, either to experiment with trading, or in order to experience the ups and downs of trading without risking any real money. Other organisations allow users to trade in imaginary “shares”, e.g. shares that relate to celebrities, films or records. The present invention can equally be applied to the virtual balances in such “accounts”, and the terms “financial institution” and “account” in the present invention apply equally to such organisations and virtual accounts.

Preferably the amount displayed shows the interest accumulated to a sufficient number of decimal positions that all customers are able to observe regular changes to the amount displayed, regardless of the balance of their account. By “regular changes”, we mean that the amount displayed changes sufficiently often for a user to be able to see one or more changes during the time that the amount is viewed. Preferably the amount displayed changes at least once every 10 seconds, more preferably at least once every 5 seconds.

Users who are only accessing their account to check a particular detail may only view the web page for a short period of time, and it is preferable that even during such short viewings a user is able to observe a change to the accumulated interest display.

The term “decimal positions” is used to cover all the constituent digits of a number, whether these positions are decimal places (occurring after the decimal point: tenths, hundredths, etc.) or positions occurring before the decimal point (e.g. tens, hundreds, thousands, etc.).

The number of decimal positions that is sufficient for each account may vary depending on several factors, such as the balance of the account, the interest rate applying to the account, and/or the currency in which the account is denominated. In certain circumstances it may be useful to display one or more trailing or leading zeros in the most significant or least significant decimal positions displayed. Any such leading or trailing zeros may be fixed as they are not expected to change whilst the displayed amount is being viewed.

In particular it has been found that when display interest amounts for accounts denominated in US Dollars, Pounds Sterling or Euro, regular changes can in general be displayed if up to five decimal places (i.e. 1/100,000 of the base currency unit (Dollar, Pound, Euro)) are displayed. For accounts denominated in currencies where the basic unit of currency is of lower value (e.g. Turkish Lira or Indian Rupees), fewer (or even no) decimal places will be required for regular changes to be displayed, although the same number (or more) decimal positions may be required, for example particularly for accounts with a high balance.

The method may adjust the number of decimal positions to which the interest is displayed. Preferably such adjustment is made so that each customer using the web page is able to observe regular changes to the counter display as above. This adjustment may be made according to one or more of the following factors: the currency in which the account is held; the balance of the account; the interest rate applying to the account, or other factors which affect the rate at which the amount displayed by the counter changes.

In many cases, the number of decimal positions displayed will be such that the value represented by the lower decimal positions is much less than the smallest currency unit used or the smallest integer amount of interest that will actually be credited to or debited from an account. In such situations, the display may display those decimal positions which represent an amount of interest that is above the smallest amount or unit may be displayed in a different colour to those decimal positions which represent an amount of interest that is below that smallest amount or unit.

The format in which the amount is displayed may be in the form of a digital display, such as those found on digital watches or alternatively in the form of a continuously moving rotary meter, such as those found in vehicle odometers or utility meters.

The method may also include the steps of calculating the tax payable on the calculated amount of interest, and thus a net amount of interest which has accumulated on the account, and displaying one or more of: the gross amount of interest accumulated; the net amount of interest accumulated; and the tax payable. The method may also include the step of displaying the tax rate that has been applied. Where more than one of the above items are displayed, the above described preferred and optional features may apply to each of the items displayed.

A further aspect of the present invention provides a computer program which, when executed by a computer, performs a method for displaying the amount of interest that has accumulated on an account since a predetermined time in the past, the method including the steps of: selecting an account; calculating the amount of interest accumulated on said account since a predetermined time in the past; displaying said amount of interest.

The method performed by said computer program, when executed by a computer, include any or all of the optional or preferable features described in relation to the first aspect above.

Another aspect of the present invention provides a computer program product containing a computer program which, when executed by a computer, performs a method for displaying the amount of interest that has accumulated on an account since a predetermined time in the past, the method including the steps of: selecting an account; calculating the amount of interest accumulated on said account since a predetermined time in the past; and displaying said amount of interest.

The method performed by said computer program contained on said computer program product when executed by a computer, may include any or all of the optional or preferable features described in relation to the first aspect above.

Another aspect of the present invention provides a web page generated by performing a computer-implemented method for displaying the amount of interest that has accumulated on an account since a predetermined time in the past, the method including the steps of: selecting an account; calculating the amount of interest accumulated on said account since a predetermined time in the past; generating a web page; and displaying said amount of interest on said web page.

Since many customers are now using the internet/WWW to view and/or manage their finances, the present invention offers a tool to these customers to allow them to see interest accumulation on their accounts. The present invention also allows financial institutions to offer a service to their customers via their web page(s).

The computer-implemented method which generates said web page may also include any or all of the optional or preferable features described in relation to the first aspect above.

Another aspect of the present invention provides a web page which, when requested by a client computer system from a server computer system, causes a program to be transferred from the server computer system to the client computer system and to be executed on the client computer system, wherein execution of said program performs a method for displaying the amount of interest that has accumulated on an account since a predetermined time in the past, the method including the steps of: selecting an account; calculating the amount of interest accumulated on said account since a predetermined time in the past; and displaying said amount of interest.

The method performed by the execution of said computer program stored may include any or all of the optional or preferable features described in relation to the first aspect above.

Where the present invention relates to a program which, when executed, causes the method of the invention to be implemented over a network, or to a web page, the program or method is preferably configured to run on a client computer (e.g. as an applet), thereby reducing the need for constant communication of data from the server computer to the client computer to maintain an accurate rate of adjustment of the displayed number. By repeating the steps of the method on a client computer, for example based on initial data supplied when the program or method is first started, no further data need be communicated to the client computer.

Where the present invention relates to a web page and the program or method is configured to run on a client computer, the web page preferably causes the program to be transferred to the client computer. Either the web page or the program may cause the transfer of data relating to the program, which preferably includes one or more of: the account balance at a predetermined time; the applicable interest rate; and the amount of interest already accumulated on the account.

By transferring the program to the client computer, the amount of information sent between the client computer and a server (e.g. the server hosting the web page) is reduced, and the program can run on the client computer independently of whether a connection to the server computer exists.

Further, by transferring data relating to the program to the client computer with the program, the program can run on the client computer without the need for any communication with the server computer.

A further aspect of the present invention provides a computer system having a processor and a display, the processor being operably configured to receive data relating to an account; to calculate the amount of interest accumulated on said account since a predetermined time in the past; and to display said amount of interest on said display.

The computer system of this aspect may be, but is not limited to, a standard personal computer, a laptop computer, a handheld computer, a personal organiser, a personal data assistant (PDA), a mobile telephone or a proprietary display provided by the financial institution holding the account.

The computer system may be further configured to carry out any or all of the optional or preferable features described in relation to the method of the first aspect above.

Another aspect of the present invention provides a computer system comprising a server computer connected to a network and a second computer also connected to said network, wherein said server computer stores a computer program which, when executed by said second computer, performs a method for displaying the amount of interest that has accumulated on an account since a predetermined time in the past, the method including the steps of: selecting an account; calculating the amount of interest accumulated on said account since a predetermined time in the past; displaying said amount of interest.

The method performed by the computer program stored on said server may include any or all of the optional or preferable features described in relation to the first aspect above.

### BRIEF DESCRIPTION OF THE DRAWINGS

FIG. 1 is a schematic illustration of a web page according to an embodiment of the invention;

FIG. 2 shows one possible format of an accumulated interest display as used in an embodiment of the invention;

FIG. 3 shows another possible format of an accumulated interest display as used in another embodiment of the invention; and

FIG. 4 shows a computer network arrangement on which the present invention may be embodied.

### DESCRIPTION OF A PREFERRED EMBODIMENT OF THE INVENTION

A preferred embodiment of the present invention provides an web page containing a continuously changing display, the value displayed on that display being the amount of interest accrued or accumulated on a particular customer account since a predetermined time. Preferably the web page also displays further details of the customer account to which the dial relates, in particular the current balance of that account and the present interest rate which applies to the account. Other features which are well known from existing internet banking sites, such as the ability to transfer funds, request a statement or pay a bill may also be included.

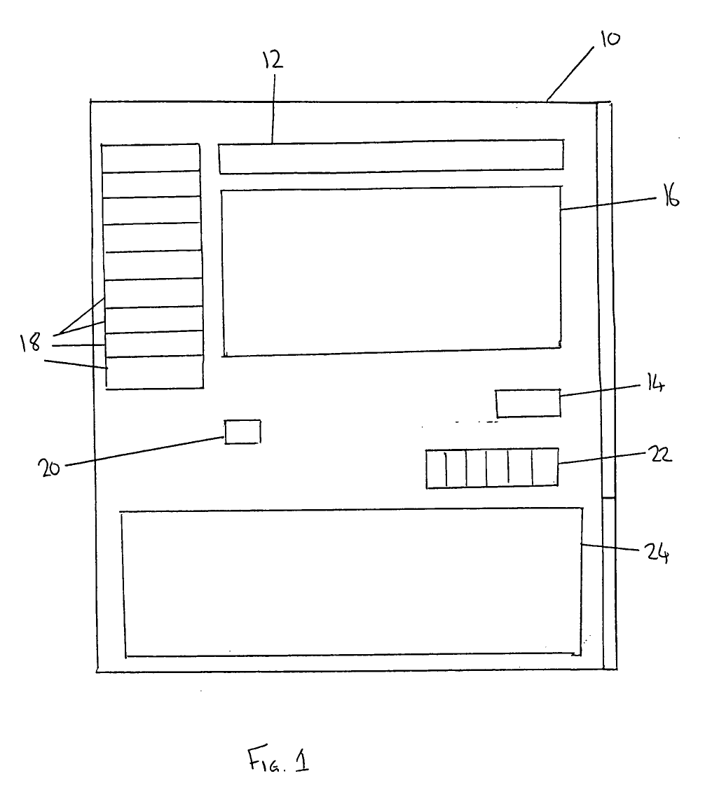

A web page 10 according to the preferred embodiment is illustrated schematically in FIG. 1. It displays account details 12, which may include the account number, the account holder and/or other references. The web page 10 also displays the account balance 14 and a history of recent transactions 16 and has a plurality of hyperlinks 18 to other features associated with the account, such as the ability to transfer funds to or from the account, request changes to overdraft or credit limits, etc. The web page 10 also displays 20 the interest rate currently applicable to the account and any special conditions attaching to that rate (e.g. fixed term of deposit, length of special rate remaining).

An accumulated interest display 22 displays the amount of interest accumulated on the account since a predetermined time in the past. The accumulated interest display 22 is driven by a program which is caused to run by the downloading of the web page 10. This program runs continuously whilst the web page 10 is displayed, thereby updating the accumulated interest displayed on accumulated interest display 22 on a substantially constant basis.

Web page 10 also includes a legal and information statement 24, which may indicate that the implementation of the invention has been overseen or are monitored by a supervisory body. The supervisory body may oversee that the correct technology and parameters have been applied to result in a correct amount of accumulated interest being displayed on accumulated interest display 22. The legal and information statement 24 may also contain details as to how and when the interest displayed on accumulated interest display 22 will be credited to or debited from the account.

Web page 10 may also include a reset button (not shown) which instructs the program to restart the calculation of the accumulated interest displayed on display 22 from the present time.

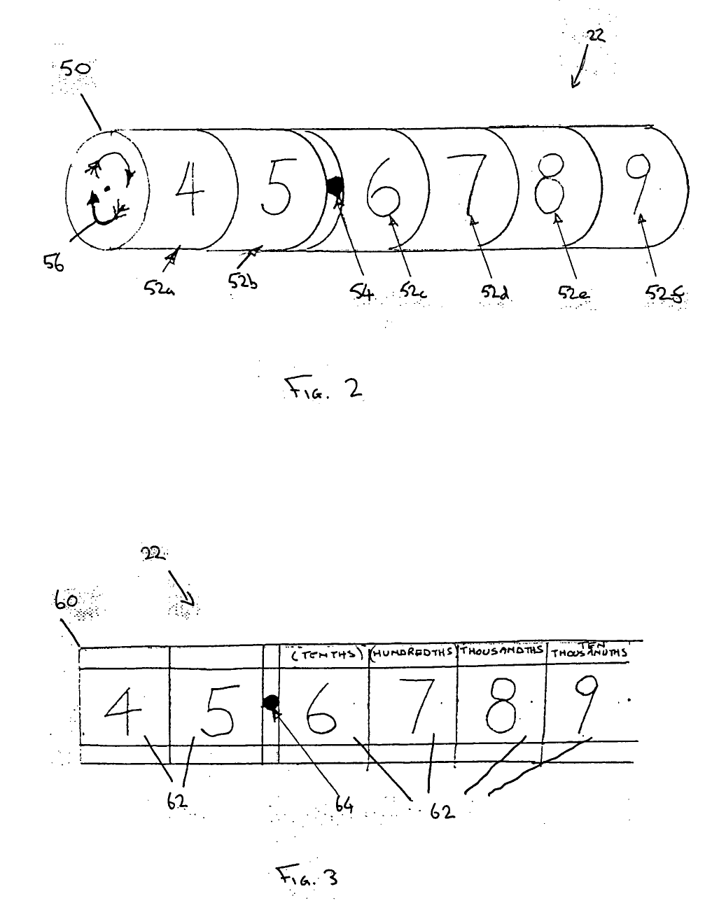

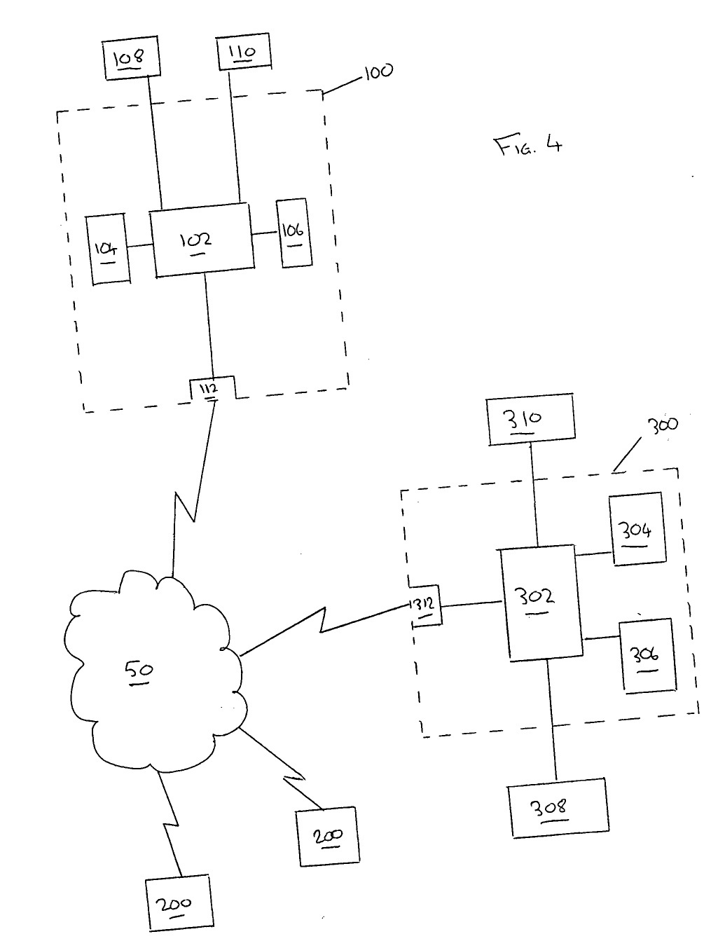

Two possible formats of the accumulated interest display 22 are shown in FIGS. 2 and 3.

In FIG. 2, the accumulated interest display 22 takes the form of a continuously moving rotary meter 50 which comprises a number of rotating cylinders 52a, 52b, 52c, 52d, 52e and 52f on which the numbers 0 to 9 are printed in sequence and a fixed decimal point 54. As the accumulated interest to be displayed increases, the cylinder representing the least significant digit rotates in the direction shown by arrow 56, thus increasing the number displayed. The other cylinders in the display rotate at a proportionally slower rate ( 1/10^{th} of the rate of the cylinder to their right) so that when cylinder 52f has completed a rotation, cylinder 52e has rotated to display the next number and so on. The display may show the rotary meter 50 in a three-dimensional view as shown in FIG. 2, or in a two-dimensional view. Although the calculation of the accumulated interest is carried out digitally, the amount is displayed in a “mechanical” form, and so a continuous movement of the display may be observed.

The display of FIG. 2 can also be adapted to only display discrete changes in the amount rather than continuous motion, for example only changing when the number to be displayed by the least significant digit 52f changes. This results in a jerky motion of the counter, which may be more eye-catching.

In FIG. 3, the accumulated interest display 22 takes the form of a digital display 60 which comprises a number of digits 62 displayed in the appropriate decimal positions and a decimal point 64. The digits may be displayed in the standard 7-bar LCD-type display or may come from a typeset font. With the display of FIG. 3 discrete changes in the amount are displayed.

Depending on the rate at which the accumulated interest is increasing (or decreasing), many of the digits 62 of the digital display of FIG. 3 or, particularly, many of the cylinders 52 of the meter display of FIG. 2, may be visibly changing at one time, thus giving an impression of rapid accumulation (or reduction) of interest.

The program of the present invention is preferably provided in the Java™ programming language, thereby being substantially platform independent (i.e. capable of being run on most client computers regardless of the operating system or browser software that the particular computer is using).

In the preferred embodiment, the present invention is provided as a computer program which is configured to run on a conventional personal computer system connected to a network, particularly one connected to the internet.

FIG. 4 shows a such conventional personal computer system 100 on which the present invention may implemented. Processor 102 retrieves and executes software instructions stored in first storage 104, which may be memory, such as Random Access Memory (RAM), and may control other components to perform the present invention.

First storage 104 may be used to store program instructions or data or both. Second storage 106, such as a computer disk drive or other non-volatile storage, may provide storage of data or program instructions instead of or in addition to first storage 104.

In one embodiment, second storage 106 provides longer term storage of instructions and data, with first storage 104 providing storage for data or instructions that may only be required over a shorter time span.

An input device 108, such as a computer keyboard or mouse or both, allows user input to the system 100. An output device 110, such as a display or printer, allows the system to provide information such as instructions, data or other information to the user of the personal computer system 100.

Personal computer system 100 is connected to the network 50 via an interface unit 112, such as a modem or a network adapter. Network 50 is preferably the internet or a part of the internet. However, in alternative embodiments, network 50 could be an internal network.

Other computers 200 are also connected to network 50.

Also connected to network 50 is server system 300. Server system 300 may be a conventional server computer. on which the program of the present invention may be stored or implemented. Processor 302 retrieves and executes software instructions stored in first storage 304, which may be memory, such as RAM, and may control other components to perform the present invention.

First storage 304 may be used to store program instructions or data or both. Second storage 306, such as a computer disk drive or other non-volatile storage, may provide storage of data or program instructions instead of or in addition to first storage 304.

Storage input device 314 such as a conventional floppy disk drive or CD-ROM drive accepts computer program products such as a conventional floppy disk, CD-ROM or other non-volatile storage media that may be used to transport computer instructions or data to the system 300.

Such computer program product(s) may have encoded thereon computer readable program code devices, such as magnetic charges in the case of a floppy disk or optical encodings in the case of a CD-ROM, which are encoded as program instructions, data or both and which, when loaded onto system 300 configure the system 300 to operate in accordance with the present invention.

In a preferred method of operation, a program and a web page according to the present invention are stored on server system 300.

A user of client system 100 uses an internet browser to log on to server system 300 and request a web page relating to the user's account (or a specified one of the user's accounts).

The web page relating to the selected account is downloaded to client system 100. The web page is typically a template web page such as that illustrated schematically in FIG. 1, and is downloaded along with data relating to the selected account, including the account balance, account information and recent transactions. Also downloaded to the client system 100 is a program according to the present invention, which is configured to display as part of the web page the accumulated interest display 22. Further downloads to the client system 100 include the interest rate applying to the selected account, a predetermined time from which accumulated interest will be calculated and displayed, or alternative details which allow the program running on the client system 100 to calculate the interest accumulated on the selected account from a predetermined time.

The program calculates and refreshes the accumulated interest displayed on the web page on a regular basis, preferably at least once a second and more preferably at a rate which appears substantially continuous to a user viewing the web page. Alternatively the program may calculate the rate at which the accumulated interest is increasing and the accumulated interest displayed on the web page is substantially continuously increased at this rate. This latter method of updating the accumulated interest display may be preferable where the display is a rotary meter type of display (such as that shown in FIG. 2), the calculated rate determining the speed at which the smallest significant digit of the display rotates.

When first downloaded to the client system 100, the program may also determine the number of decimal positions which will be displayed in the accumulated interest display. This calculation takes into account the balance of the account, the interest rate applying to the account and the currency in which the account is denominated. Alternatively this determination may be carried out on server system 300 when the web page is first requested, and form a further piece of data that is transferred to the client system 100 with the web page.

In making a determination as to the number of decimal positions which will be displayed in the accumulated interest display, the principal consideration is that the number of decimal positions which are to be displayed will be such that any user is able to observe changes to the accumulated interest display whilst viewing the web page, regardless of the balance of their account, the interest rate applying to the account, the currency in which the account is denominated, or any other factor.

Ideally the determination as to the number of decimal positions which will be displayed in the accumulated interest display is made such that the least significant digit in the display changes at least once every 10 seconds, more preferably such that the least significant digit changes at least once every 5 seconds. Users who are only accessing their account to check a particular detail may only view the web page for a short period of time, and it is preferable that even during such short viewings a user is able to observe a change to the accumulated interest display.

When the client system 100 is a mobile telephone or other personal device (PDA, handheld computer, etc.), at least part of network 50 is preferably wireless, thus allowing the user to access their account information and use the present invention on the move or from remote locations.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A computer-implemented method for displaying the amount of interest that has accumulated on an account since a predetermined time in the past, the method including the steps of: selecting an account; calculating the amount of interest accumulated on said account since a predetermined time in the past; and displaying said amount of interest.

2. The method according to claim 1 wherein said amount displayed is effectively constantly updated.

3. The method according to claim 2 wherein said amount displayed is updated at least once a second.

4. The method according to claim 1 wherein said amount displayed is displayed on a web page.

5. The method according to claim 1 wherein said amount displayed is displayed to a sufficient number of decimal positions that the displayed amount changes at least once every 10 seconds.

6. The method according to claim 5 wherein said amount displayed is displayed to a sufficient number of decimal positions that the displayed amount changes at least once every 5 seconds.

7. The method according to claim 1 wherein said amount displayed is displayed to 5 decimal places.

8. The method according to claim 1 further including the step of determining the number of decimal positions to which the calculated amount of interest is displayed.

9. The method according to claim 8 wherein the step of determining is carried out such that the amount displayed changes at least once every 10 seconds.

10. The method according to claim 8 wherein the step of determining uses one or more of the following factors: the currency in which the account is held; the balance of the account; the interest rate applying to the account.

11. The method according to claim 1 wherein the amount displayed is displayed in the form of a digital display.

12. The method according to claim 1 wherein the amount displayed is displayed in the form of a continuously moving rotary meter.

13. The method according to claim 1, further including the step of generating a web page on which the amount of interest is displayed.

14. The method according to claim 13 wherein the web page also displays other details relating to the account.

15. A computer program which, when executed by a computer, performs a method for displaying the amount of interest that has accumulated on an account since a predetermined time in the past, the method including the steps of: selecting an account; calculating the amount of interest accumulated on said account since a predetermined time in the past; displaying said amount of interest.

16. A computer program product containing a computer program which, when executed by a computer, performs a method for displaying the amount of interest that has accumulated on an account since a predetermined time in the past, the method including the steps of: selecting an account; calculating the amount of interest accumulated on said account since a predetermined time in the past; and displaying said amount of interest.

17. A web page generated by performing a computer-implemented method according to claim 13.

18. A web page which, when requested by a client computer system from a server computer system, causes a computer program according to claim 15 to be transferred from the server computer system to the client computer system and to be executed on the client computer system.

19. The web page according to claim 18 which, when requested, further causes data relating to the account to be transferred to the client computer.

20. A computer system having a processor and a display, the processor being operably configured to receive data relating to an account; to calculate the amount of interest accumulated on said account since a predetermined time in the past; and to display said amount of interest on said display.

21. A computer system comprising a server computer connected to a network and a second computer also connected to said network, wherein said server computer stores a computer program which, when executed by said second computer, performs a method for displaying the amount of interest that has accumulated on an account since a predetermined time in the past, the method including the steps of: selecting an account; calculating the amount of interest accumulated on said account since a predetermined time in the past; displaying said amount of interest.
